(19) United States
(12) Patent Application Publication
(10) Pub. No.: US 2007/0159824 A1
(43) Pub. Date: Jul. 12, 2007

(54) Bulb assembly with a decorative cover

(76) Inventor: Hsiu-Tsen Chang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,477

(22) Filed: Jan. 6, 2006

(51) Int. Cl. F21V 14/00

(52) U.S. Cl. 362/255

(57) ABSTRACT

The invention relates to a bulb assembly with a decorative cover. The bulb assembly includes a shell, a holder, and a bulb, and the decorative cover can be connected with the bulb assembly by special positioning structure. The decorative cover has several branches with different surface planes and is transparent. As the bulb is lightened, the ray passes through the branches of the cover that displays a special lighting effect.

### BACKGROUND OF THE INVENTION

A conventional bulb assembly includes a shell, a holder, and a bulb, which is connected on a light string for decorative effect. The known structure is simple and monologue. Each bulb emits light outward directly without any novelty. Thus, the conventional bulb assembly should be improved.

The present invention is to provide a bulb assembly with a decorative cover, which provides a special decorative effect and is better than ever. Now, accompanying with the following drawings, the character of the present invention will be described here and after.

### BRIEF DESCRIPTION OF THE DRAWINGS

FIG. 1 is a perspective view showing a bulb assembly with a decorative cover according to the present invention.

FIG. 2 is an exploded perspective view of FIG. 1.

FIG. 3 is a cross-sectional plan view of FIG. 1.

FIG. 4 is a perspective view showing a modified bulb assembly with a decorative cover according to the present invention.

FIG. 5 is a cross-sectional plan view of FIG. 4.

FIG. 6 is a perspective view showing another modified bulb assembly with a decorative cover according to the present invention.

FIG. 7 is a cross-sectional plan view of FIG. 6.

### DETAILED DESCRIPTION OF THE PREFERRED EMBODIMENT

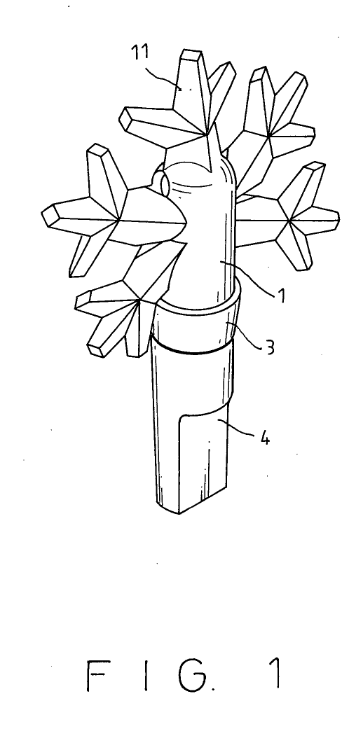

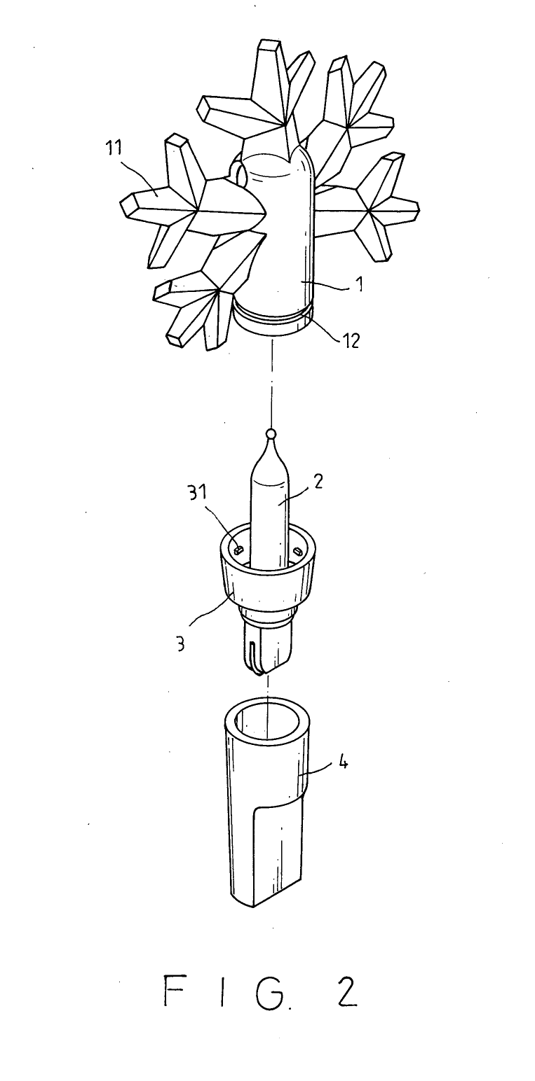

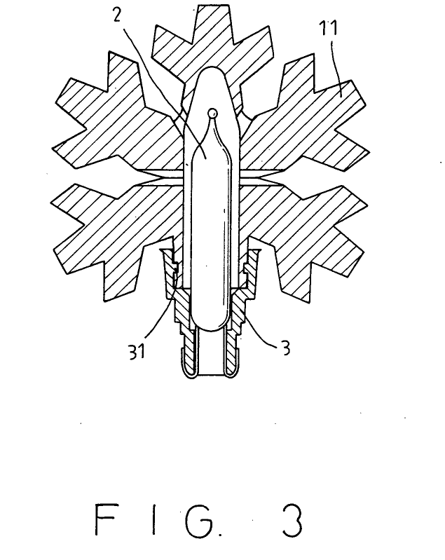

Referring to FIG. 1 to 3, the present invention relates to a connecting structure of a bulb assembly and a decorative cover (1). The bulb assembly is provided on a light string and includes a shell (4), a holder (3), and a bulb (2). The holder (3) has several projections (31) formed in its upper inner base. The decorative cover (1) made of transparent material has several branches (11), each of which has different surface planes. The decorative cover (1) has a lower annual groove (12). When the decorative cover (1) connects with the holder (3), the projections (31) are placed in the annual groove (12) that obtains a secure connection between both, while the cover (1) can still rotate on the bulb assembly and will not separate.

In use, when the bulb (3) is on, it emits light, which passes through each branches (11) of the cover (1) and produces diffusing effect that makes a shining and beautiful outlook just as a diamond. Hence, the light string connecting with the bulb assemblies having the decorative covers can obtain a unique and better decorative effect than any prior structure.

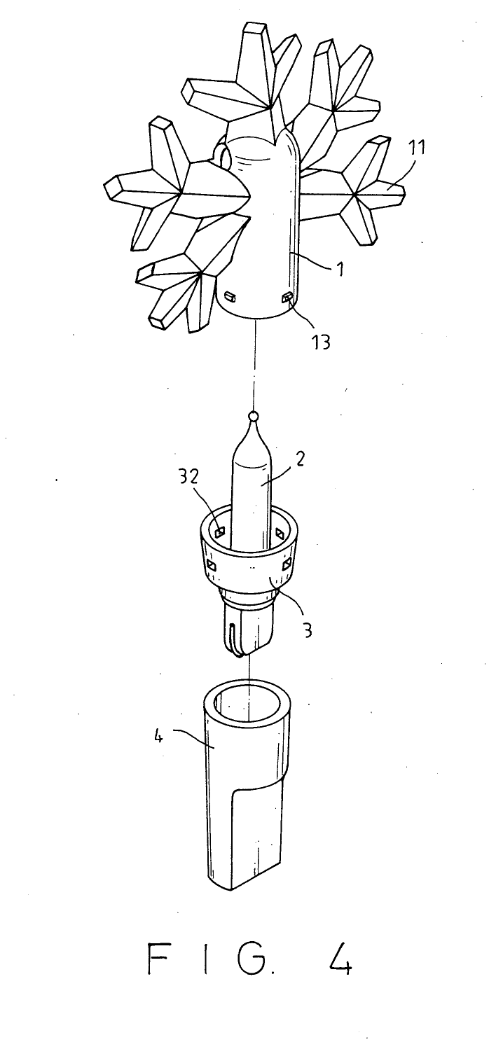

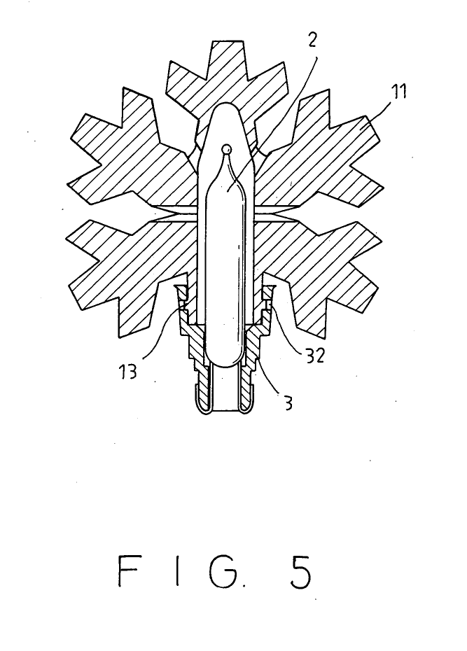

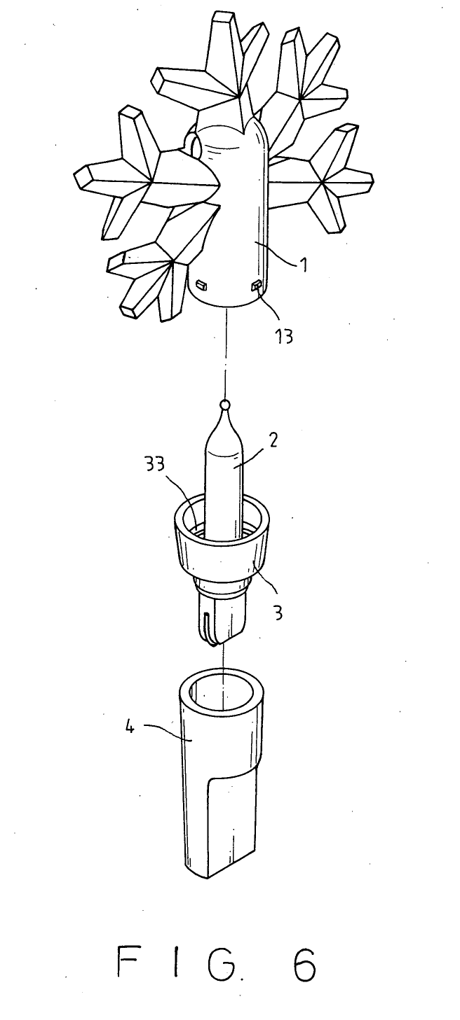

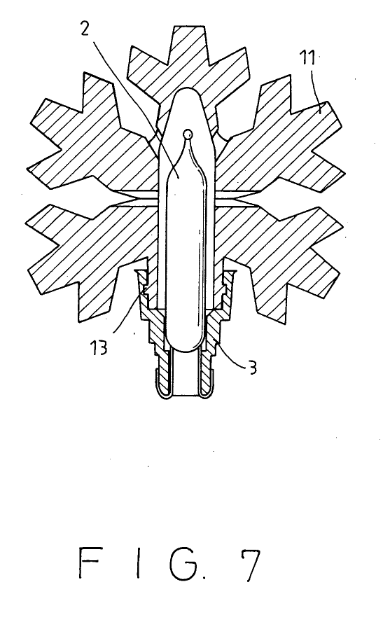

It is also to be understood that the above-mentioned embodiments are only exemplary of the present invention. Any modification with the same or similar merit is still claimed in this application, such as shown in FIG. 4 and 5, a modified bulb assembly with a decorative cover is shown, wherein the cover (1) has its lower end several projections (13) and the holder (3) has several grooves (32) on its upper base. When the cover (1) connects with the holder (3), each projection (13) is engaged with a related groove (32) that the cover (1) is then connected with bulb assembly firmly. Referring to FIG. 6 and 7, it shows another modified embodiment according to above structure, wherein the holder (3) has an annual groove (33) formed in its upper base. When the cover (1) connects with the holder (3), the projections (13) are placed in the groove (33) that the cover (1) can still rotate on the bulb assembly and will not separate from the bulb assembly.

Accordingly, the present invention obtains utilization and improvement and should be allowed for patent.

I claim:

1. A bulb assembly with a decorative cover including a bulb assembly and a decorative cover, wherein the bulb assembly includes a shell, a holder, and a bulb and the decorative cover made of transparent material has several branches, each of which has different surface planes, and the decorative cover is connected on the bulb assembly.

2. The bulb assembly with a decorative cover as claimed in claim 1, wherein every bulb assembly connected on a light string connects with a related decorative cover.

3. The bulb assembly with a decorative cover as claimed in claim 1, wherein the bulb assembly is consisted of a shell, a holder, and a bulb, and the cover is connected with the holder.

4. The bulb assembly with a decorative cover as claimed in claim 1, wherein the cover has its lower end an annual groove and the holder has several projections in its upper base, which are placed in the groove when the cover connects with the holder.

5. The bulb assembly with a decorative cover as claimed in claim 1, wherein the cover has its lower end several projections and the holder has its upper base several grooves, each of which engages with a related projection when the cover connects with the holder.

6. The bulb assembly with a decorative cover as claimed in claim 1, wherein the cover has its lower end several projections and the holder has its upper base an annual groove for receiving the projections when the cover connects with the holder.
